(19) United States
(12) Patent Application Publication
(10) Pub. No.: US 2026/0269908 A1
(43) Pub. Date: Sep. 10, 2026

(54) OPTIMAL SINGULAR VALUE DECOMPOSITION BASED BEAMFORMING

(71) Applicant: Samsung Electronics Co., Ltd., Gyeonggi-do (KR)

(72) Inventors: Aiguo YAN, San Jose, CA (US); Eunsung JEON, Gyeonggi-do (KR); Dongwoon BAI, San Diego, CA (US); Jung Hyun BAE, San Diego, CA (US)

(21) Appl. No.: 19/537,125

(22) Filed: Feb. 11, 2026

Related U.S. Application Data
(60) Provisional application No. 63/767,970, filed on Mar. 6, 2025.
(60) Provisional application No. 63/770,844, filed on Mar. 12, 2025.
(60) Provisional application No. 63/846,328, filed on Jul. 18, 2025.
(60) Provisional application No. 63/875,166, filed on Sep. 3, 2025.
(60) Provisional application No. 63/874,893, filed on Sep. 3, 2025.
(60) Provisional application No. 63/880,292, filed on Sep. 11, 2025.

(51) Int. Cl. H04B 7/06

(52) U.S. Cl. CPC H04B 7/0626; H04B 7/0617

(57) ABSTRACT

A method, system, and station are disclosed for forming, optimal singular value decomposition based beamforming. The method, system, and station may form, with a first station (STA1), a normalized-optimal STA1 CSI feedback matrix V̅₁ with an optimal STA1-first access point (AP1) intra-basic service set (BSS) right singular matrix \tilde{V}₁₁, a normalized new STA1-second access point (AP2) cross-BSS right singular matrix

$${\overline{V}}_{12}^{new} ,$$

and a null matrix. The method, system, and station also sends, with the STA1, the normalized-optimal STA1 CSI feedback matrix V̅₁ to the AP1 and AP2 for more than one type of beamforming.

### CROSS-REFERENCE TO RELATED APPLICATION

This application claims the priority benefit under 35 U.S.C. § 119(e) of U.S. Provisional Application No. 63/767,970, filed on Mar. 6, 2025, U.S. Provisional Application No. 63/770,844, filed on Mar. 12, 2025, U.S. Provisional Application No. 63/880,292, filed on Sep. 11, 2025, U.S. Provisional Application No. 63/875,166, filed Sep. 3, 2025, U.S. Provisional Application No. 63/874,893, filed on Sep. 3, 2025, and U.S. Provisional Application No. 63/846,328, filed on Jul. 18, 2025, the disclosure of each of which is incorporated by reference in its entirety as if fully set forth herein.

### TECHNICAL FIELD

The disclosure generally relates to performing decomposition for beamforming. More particularly, the subject matter disclosed herein relates to optimal singular value decomposition (SVD) based beamforming.

### SUMMARY

In wireless networks, an access point (AP) can serve as a hub for a plurality of wireless network devices referred to as stations (STAs). The STAs are typically within a service area of an associated AP. The STAs may be fixed, mobile, semi-fixed, etc. The STAs may be communicatively coupled with at least the associated AP. That is, a given STA may be associated with only one AP but can communicate with non-associated APs. In addition, the STAs associated with a given AP typically do not communicate directly with each other within the wireless network. However, the STAs may have additional localized wireless features, such as Bluetooth, non-AP associated wireless fidelity (Wi-Fi) networks, ad hoc mesh networks, etc. A given STA can be in a service area of two or more APs. For example, an STA may be in a first service area associated with a first AP (AP1), a second service area associated with a second AP (AP2), and/or etc.

FIG. 1 is a schematic of a system 100 including an overlapping basic service set (OBSS) between AP1 and AP2 according to an embodiment.

Referring to FIG. 1, six STAs are shown, where four of the STAs are located in service areas associated with both AP1 and AP2. Associations between the six STAs and their respective APs are illustrated as comm-links depicted by lightning bolts. As shown in FIG. 1, the STA1, STA2, and STA5 may be associated with AP1. In addition, STA3, STA4, and STA6 are shown as associated with AP2. The STA1, STA2, STA3, and STA4 are in an overlapping service area.

Standards may use differing terms for similar functions. Accordingly, “access point” or “AP” may be used interchangeably with other terms, such as a “base station,” “station functioning as an access point,” etc. As described herein, a wireless network of an AP and its associated STAs can be referred to as a basic service set (BSS). The term OBSS can refer to BSSs that partially overlap. From a geographic perspective, the OBSS can be viewed as overlapping service areas.

An AP can be any configuration of hardware and software comprising a backhaul equipment for connecting to a wired network, a baseband processor for signal processing of a baseband signal, a modulating unit to modulate and demodulate between the baseband signal and a wireless signal (e.g., received or to be transmitted), and an antenna array that transmits and receives the transmission signal. The antenna array may include a plurality of antennas collectively capable of shaping the antenna's radiation patterns into directional communication beams using, for example, constructive interference between signals emitted by radiating elements of the arrays.

Various transmission modes may be employed for intra-BSS and OBSS STAs, including coordinated beamforming (Co-BF) multi-user (MU)-multiple input, multiple output (MIMO), and/or single user (SU)-MIMO. MU-MIMO may be the use of beamforming by a single AP to transmit to a particular STA. Co-BF is the use of beamforming by two APs to transmit to a single STA. Beamforming may use antenna arrays comprised of antennas to shape the constructive and destructive interference of the radiation patterns.

To address this issue, the beamforming can use precoding matrices P that are applied to each antenna's output. Transmission from an AP to a STA may be decoded by using a receiver processing matrix Q. The precoding matrices P and the receiver processing matrices Q can be determined based on channel matrices H between the AP antennas and STA antennas. With more particularity, various sounding methods can determine a channel matrix H and various decomposition and matrix manipulation methods can determine the precoding matrices P and the receiver processing matrices Q based on the channel matrices H.

To help with predicting, for example, a propagation of data through the channels, an AP may employ beamformed channels H·V. The channel matrices H and the beamformed channels H·V may be noisy. Smoothing filtering can be performed on the channel matrices H to reduce the noise but may not be employed on typical beamformed channels H·V. Channel smoothing may be performed on beamformed channels H·\tilde{V}, where \tilde{V} is an optimal right singular matrix. However, the optimal right singular matrix V may not be feedbacked due to constraints imposed by, for example, Wi-Fi standards.

To overcome these issues, systems and methods are described herein for optimal SVD based beamforming.

The above approaches improve on previous methods because the optimal right singular matrix \tilde{V} may be feedbacked. As a result, smoothing filtering can be performed on beamformed channels H·\tilde{V}, where \tilde{V} is an optimal right singular matrix at an AP. This can allow the AP to, for example, predict the propagation of data through the channels.

In an embodiment, a method comprises forming, with the STA1, a normalized-optimal STA1 CSI feedback matrix V̅₁ with an optimal STA1-AP1 intra-BSS right singular matrix \tilde{V}₁₁, a new STA1-AP2 cross-BSS normalized right singular matrix

$${\overline{V}}_{12}^{new} ,$$

and a null matrix and sending, with the STA1, the normalized-optimal STA1 CSI feedback matrix V̅₁ to the AP1 and the AP2 for more than one type of beamforming.

In an embodiment, a STA comprises a processing circuit configured to form a normalized-optimal STA CSI feedback matrix V̅₁ with an optimal STA-AP1 intra-BSS right singular matrix \tilde{V}₁₁, a new STA-AP2 cross-BSS normalized right singular matrix

$${\overline{V}}_{12}^{new} ,$$

and a null matrix and a transmitter/receiver configured to send the normalized-optimal STA CSI feedback matrix V̅₁ to the AP1 and the AP2 for more than one type of beamforming.

In an embodiment, a AP1 and a STA communicatively coupled with the AP1, the STA being configured to form a normalized-optimal STA CSI feedback matrix V̅₁ with an optimal STA-AP1 intra-BSS right singular matrix ii, a normalized new STA-AP2 cross-BSS right singular matrix

$${\overline{V}}_{12}^{new} ,$$

and a null matrix and a transmitter/receiver configured to send the normalized-optimal STA CSI feedback matrix V̅₁ to the AP1 and the AP2 for more than one type of beamforming.

### BRIEF DESCRIPTION OF THE DRAWING

In the following section, the aspects of the subject matter disclosed herein will be described with reference to exemplary embodiments illustrated in the figures, in which:

FIG. 1 is a schematic of a system 100 including an OBSS between AP1 and AP2 according to an embodiment.

FIG. 2 depicts an example system 200 for optimal SVD for beamforming.

FIG. 3 is a sequence diagram 300 for sequential sounding using SVD.

FIG. 4 is a sequence diagram 400 for joint SVD with joint sounding in Co-BFing.

FIG. 5 is a sequence diagram 500 for separated SVD with sequential sounding.

FIG. 6 is a sequence diagram 600 for separated SVD with joint sounding.

FIG. 7 is a method 700 for optimal SVD based beamforming.

FIG. 8 is a method 700 for optimal SVD based beamforming.

FIG. 9 is a block diagram of an electronic device in a network environment 900, according to an embodiment.

FIG. 10 shows a system 1000 including an AP1 1010, an AP2 1020, and a STA 1030.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

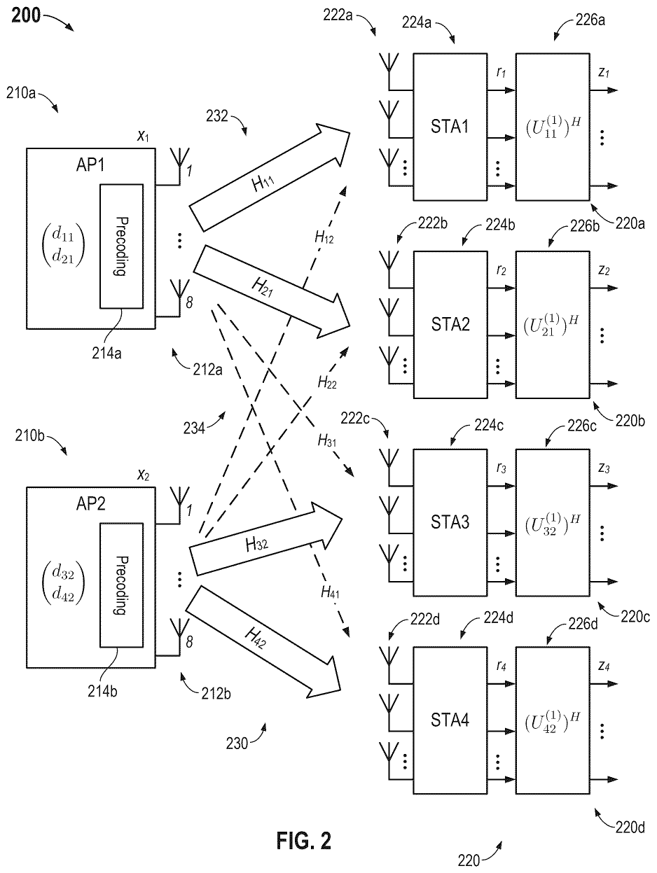

FIG. 2 depicts an example system 200 for optimal SVD for beamforming.

Referring to FIG. 2, the system 200 includes APs 210 and STAs 220. The APs 210 are comprised of a AP1 210a and a AP2 210b. The STAs 220 may include a STA1 220a, a STA2 220b, a STA3 220c, and a STA4 220d. The APs 210 may be coupled, desirably or not, with the STAs 220 via channels 230. The AP1 and AP2 210a, 210b may respectively include a AP1 antenna array 212a and a AP2 antenna array 212b and a AP1 and AP2 precoding modules 214a, 214b. The STA1 through STA4 220a-220b may respectively include a STA1 through STA4 antenna arrays 222a-222d, a STA1 through STA4 receivers 224a-224d, and a STA1 through STA4 processing modules 226a-226d. The channels 230 may be comprised of intra-BSS channels 232 and cross-BSS channels 234. The channels 230 are represented by arrows, where solid arrows can represent the intra-BSS channels 232 and the dashed arrows may represent the cross-BSS channels 234.

### Associated Stations and Data

The AP1 210a may be associated with the STA1 and STA2 220a, 220b. The AP2 210b may be associated with the STA3 and STA4 220c, 220d. The AP1 and AP2 210a, 210b may accordingly include data that are intended for a downlink transmission to their respectively associated STAs. For example, the AP1 210a may include an AP1 data vector

$$( \begin{matrix}{d}_{11} \\ {d}_{21}\end{matrix} )$$

and the AP2 210b may include an AP2 data vector

$$( \begin{matrix}{d}_{32} \\ {d}_{42}\end{matrix} ) .$$

The AP1 and AP2 data vector elements d₁₁, d₂₁, d₃₂, and d₄₂ may be data streams.

The subscripts indicate the STA-AP channel a given data stream is to be transmitted over. For example, the data stream d₂₁ may be transmitted from AP1 to STA2. Accordingly, during SU-MIMO and MU-MIMO, the data stream d₂₁ may be transmitted from AP1 to STA2. However, during Co-BF one or more additional APs may be employed. For example, the STA2 220b may receive the data stream d₂₁ from the AP1 210a and the AP2 210b, simultaneously. The data streams d₁₁, d₂₁, d₃₂, and d₄₂ may be transmitted via the AP1 and AP2 antenna arrays 212a, 212b to the subscript indicated STAs.

### AP Antenna Arrays

The AP1 and AP2 antenna arrays 212a, 212b are each shown as including a first through eighth antenna. The antennas of the AP1 and AP2 antenna arrays 212a, 212b can be configured to transmit and/or receive signals. The phase and magnitude of carrier signals from each of the antenna in one of the AP1 or AP2 antenna array 212a, 212b may be manipulated to form a “beam.” The beam can be a spatial region of constructive interference of the carrier signals emitted by the antennas of the AP1 or AP2 antenna array 212a, 212b. Nulls occur in spatial regions of destructive interference of the carrier signals from the antennas in the AP1 or AP2 antenna array 212a, 212b destructively interfere. The beam may be directed in spatial path(s) that can maximize a signal strength at one of the associated STAs.

### Precoding Modules

The AP1 and AP2 precoding modules 214a, 214b can be used to calculate the desired phase and magnitude of the signals emitted by the antennas of the AP1 or AP2 antenna array 212a, 212b. For example, by way of illustration, the AP1 210a can use a precoding matrix P in the AP1 precoding modules 214a to adjust the magnitude and/or phase of a signal carrying data on a per antenna basis prior to transmission. The phase and magnitude of the signals emitted by the antennas of the first or AP2 antenna array 212a, 212b may be adjusted to form the beams. The precoding matrices P in the AP1 and AP2 precoding modules 214a, 214b can be determined using various decomposition methods, described in more detail in the following, based on the channels 230.

### Channel Matrices

Referring to FIG. 2, the intra-BSS channels 232 include channel matrix labels indicating a channel between one of the STAs 220 and one of the APs 210. As shown in FIG. 2, the intra-BSS channels 232 are labeled with an STA1-AP1 channel matrix H₁₁, STA2-AP1 channel matrix H₂₁, a STA3-AP2 channel matrix H₃₂, and a STA4-AP2 channel matrix H₄₂. Accordingly, a channel matrix Hᵢⱼ notation may include subscripts where subscript “i” indicates a STA and subscript “j” indicates an AP. The channel matrix Hᵢⱼ can include complex channel coefficients hₘₙ. The complex channel coefficients hₘₙ can represent a signal propagation between an nth antenna of the AP1 or AP2 antenna array 212a, 212b and an mth antenna of the STA1 through STA4 antenna arrays 222a-222d.

For example, referring to FIG. 2, where the AP1 and AP2 antenna arrays 212a, 212b each including eight antennas and the STA1 through STA4 antenna arrays 222a-222d, each including three antennas, the STA1-AP1 channel matrix H₁₁ may be a 3×8 matrix as follows:

$${H}_{12} = [ \begin{matrix}{h}_{11} & {h}_{21} & {h}_{13} & {h}_{14} & {h}_{15} & {h}_{16} & {h}_{17} & {h}_{18} \\ {h}_{21} & {h}_{22} & {h}_{23} & {h}_{24} & {h}_{25} & {h}_{26} & {h}_{27} & {h}_{28} \\ {h}_{31} & {h}_{32} & {h}_{33} & {h}_{34} & {h}_{35} & {h}_{36} & {h}_{37} & {h}_{38}\end{matrix} ] . \qquad Equation [ 1 ]$$

By way of illustration a training signal transmitted by a 7^{th} antenna of the AP2 antenna array 212b and received by a 3^{rd} antenna of the STA1 antenna array 222a may be represented by the complex channel coefficient h₃₇. Although a 3×8 matrix is described, any suitable configuration of the APs 210 and STAs 220 can be employed. Accordingly, any suitable channel matrix with more or fewer antennas on the APs 210 and/or STAs 220 can be employed. For example, a the STA1 through STA4 antenna arrays 222a-222d may include 4 antennas and accordingly, the STA1-AP1 channel matrix H₁₁ may be a 4×8 matrix.

### STA Receivers

The STA1 through STA4 receivers 224a-224d can receive the signals transmitted by the AP1 and AP2 210a, 210b. The STA1 and STA4 receivers 224a-224d can perform various front-end related functions, such as frequency down conversion, analog-to-digital conversion (ADC), orthogonal frequency division multiplexing (OFDM) demodulation, etc. to obtain a STA1 through STA4 received signal r₁-r₄ although any suitable arrangement can be employed.

During a data transmission, the signals received by the STA1 and STA2 220a, 220b can include the data streams d₁₁, d₂₁, d₃₂, and d₄₂ described in the foregoing. The data streams d₁₁, d₂₁, d₃₂, and d₄₂ may be encoded into the signals using OFDM although any suitable encoding may be employed. When SU-MIMO and MU-MIMO, a transmission from the AP2 210b intended for the STA2 220b but received also by the STA1 220a may be considered multi-user interference (MUI). During Co-BF, both AP1 210a and the AP2 210b may transmit to the STA1 220a to provide, for example, data stream d₁₁.

### Processing Matrices

The STAs 220 can include the STA1 through STA4 processing modules 222a-222d to separate the data streams d₁₁, d₂₁, d₃₂, and d₄₂ received by the corresponding STA1 through STA4 antenna arrays 222a-222d. Referring again to the STA1 220a for the sake of discussion, the STA1 processing module 226a can separate the data stream d₁₁ from the other data streams d₂₁, d₃₂, and d₄₂ and noise of the signals received by the STA1 antenna array 222a. For example, referring again to FIG. 2, the STA1 receiver 224a can demodulate the signals received at the STA1 antenna array 222a into a received signal r₁ that may include the received data streams d₁₁, d₂₁, d₃₂, and d₄₂ and noise.

The received signals r₁ can be provided to the first processing module 226a. The received signals r₁ can include signals from the STA1-AP1 intra-BSS channel H₁₁ and the STA1-AP2 interference channel H₁₂. The STA1 processing module 226a can process the received signals r₁ to separate out the data stream d₁₁. The STA1 processing module 226a can be obtained through matrix decomposition of the channel matrix H, which will be discussed in more detail in the following. The AP1 processing module 226a can provide a recovered data stream z₁, which may ideally be the same as the data stream d₁₁.

### MUI

As discussed above, MUI can occur when a STA is receiving a signal from an associated AP and non-associated AP. The signals received by each of the STA1 through STA4 receivers 224a-224d may be comprised of desired signals and undesirable signals. For example, the STA1 220a may receive signals from the AP2 210b during SU-MIMO and MU-MIMO transmissions by the AP2 210b and thus may experience MUI. Additionally, or alternatively, the AP1 210a may perform a MU-MIMO transmission to the STA1 and STA2 220a, 220b where the STA1 220a experiences interference from the beam directed to the STA2 220b. In contrast to the undesirably interfering signals, Co-BF may be employed with the AP1 and AP2 210a, 210b to transmit data to the STA1 220a and thus signals from the AP2 210b at the STA1 220a may be desirable.

### Channel Notation

A channel matrix Hᵢⱼ notation can indicate whether the channels are intra-BSS or cross-BSS channels if the associations between the AP1 and AP2 210a, 210b and the STA1 and STA4 220a-220d are known. For example, referring to FIG. 2, the intra-BSS channels 232 include the STA1-AP1 channel H₁₁, the STA2-AP1 channel H₂₁, the STA3-AP2 channel H₃₂, and the STA4-AP2 channel H₄₂. The cross-BSS channels 234 include the STA1-AP2 channel H₁₂, the STA2-AP2 channel H₂₂, the STA3-AP1 channel H₃₁, and the STA4-AP1 channel H₄₁. A combination of the intra-BSS channels 232 and the cross-BSS channels 234 received at each of the STA1 through STA4 220a-220d can be denoted using concatenation as follows:

$${H}_{1} = [ \begin{matrix}{H}_{11} & {H}_{12}\end{matrix} ] , {H}_{2} = [ \begin{matrix}{H}_{21} & {H}_{22}\end{matrix} ] , {H}_{3} = [ \begin{matrix}{H}_{31} & {H}_{32}\end{matrix} ] , and {H}_{4} = [ \begin{matrix}{H}_{41} & {H}_{42}\end{matrix} ] .$$

### Nulling

In the context of MUI, full nulling may refer to when a given STA's antennas receive no signals desirably transmitted to other STAs. For example, referring to FIG. 2, the STA1 through STA4 received signals r₁-r₄ provided the STA1 through STA4 receivers 224a-224d may not include MUI. The full nulling where the received signals rᵢ do not include MUI may be accomplished by using suitable right singular matrices V. Partial nulling may refer to when the STA antennas receive signals from non-associated APs but the MUI can be eliminated by STA processing matrices to achieve zero-MUI at the recovered data stream zᵢ. For example, referring again to FIG. 2, the STA1 220a recovered data stream z₁ may not include MUI even though the received signals r₁ may include MUI.

### Sounding and Intra-BSSS and Cross-BSS

An intra-BSS and cross-BSS report may involve the use of sounding or transmission of training signals from one or more APs to a STA. The STA can use the training signals to determine a channel matrix Hᵢⱼ. An intra-BSS sounding may include transmitting training signals from an AP to an associated STA. A cross-BSS sounding may include transmitting training signals from an AP to a non-associated STA. Sequential sounding may include an intra-BSS sounding and a cross-BSS sounding that occurs at different times. Joint sounding may include an intra-BSS sounding and a cross-BSS sounding that occurs at the same time. The training signals may be part of an NDP transmitted by the AP.

The complex channel coefficients hᵢⱼ can determined by a STA based on the received training signals. For example, the above exemplary STA1-AP2 channel matrix H₁₂ can be obtained by transmitting training signals from the eight antennas in the AP2 antenna array 212b to the three antennas of the STA1 antenna array 222a. The STA1 220a can measure the signal received by the STA1 antenna array 222a and determine the STA1-AP2 channel matrix H₁₂. As will be explained in more detail in the following, the STA1 220a can determine the AP1 precoding module 214a and the STA1 processing module 226a from the STA1-AP2 channel matrix H₁₂.

### Decompositions

SVD can be used to decouple a channel into multiple independent data streams. SVD may include an independent SVD, a joint SVD, and a separated SVD. All three may use intra-BSS and cross-BSS CSI reports. For example, where an intra-BSS CSI report is available for a sounding from AP1 to STA1 associated with AP1, an STA1-AP1 intra-BSS channel matrix H₁₁ can be determined. Similarly, where a cross-BSS CSI report is available between, for example, the STA1 and the AP2 which may not be associated with STA1, an STA1-AP2 cross-BSS channel matrix H₁₂ can be determined.

When using SVD, the channel matrix H can be decomposed into right singular matrices V and receiver processing matrices Q=U^{H}, where the superscript H denotes a Hermitian transpose and the receiver processing matrix Q is based on a usable portion of the left singular matrix U. For example, the left singular matrix U may be an N×M matrix, where M is not necessarily equal to N. The receiver processing matrix Q may be based on a strict usable submatrix of the left singular matrix U. By way of illustration, using notation described in more detail below, the receiver processing matrix Q=(U(:,1: m))^{H} where m<n or, in other words, m≤M−1. The right singular matrices V can be used for beamforming to shape the transmissions so that transmissions from an AP to a non-associated STA includes nulling. The nulling may be partial or full. By way of illustration, the cross-BSS channel matrix H₁₂ can be used to determine a STA1-AP2 right singular matrix V₁₂, to create a null in a cross-BSS channel from AP2 to STA1.

### Independent SVD

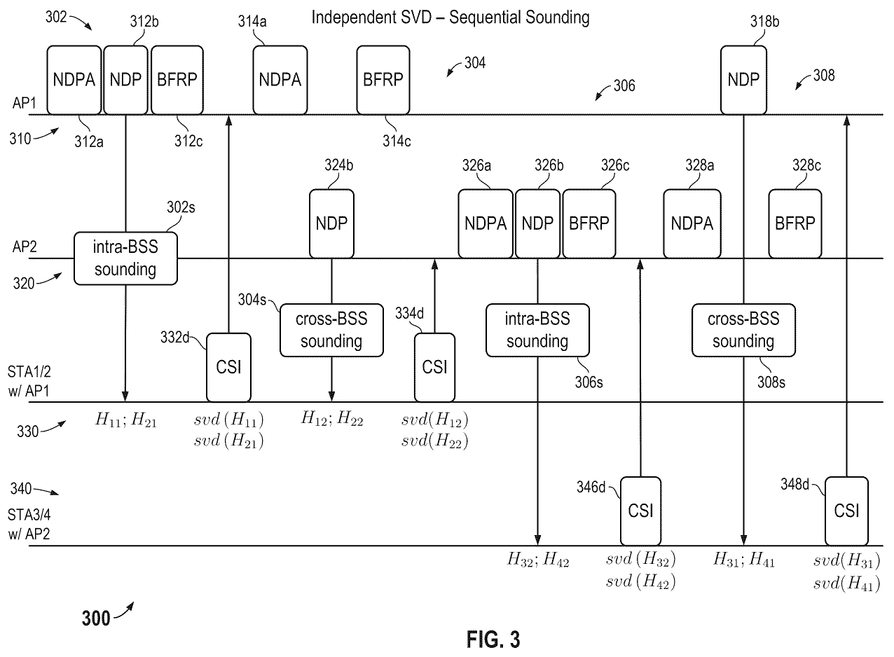

FIG. 3 is a sequence diagram 300 for sequential sounding using SVD.

Referring to FIG. 3, the sequence diagram 300 is for independent SVD with sequential sounding. The sequence diagram 300 is shown as including an AP1 sequence 310, an AP2 sequence 320, an AP1 associated STAs sequence 330, and an AP2 associated STAs sequence 340. The sequence diagram 300 is comprised of a first sequence 302, a second sequence 304, a third sequence 306, and a fourth sequence 308.

The first through fourth sequence 302-308 may begin with a null data packet announcement (NDPA) although any suitable initiating sequence step may be employed. The first through fourth sequence 302-308 may also include null data packets (NDPs), channel state indicator (CSI) reports, a beamforming report poll (BFRP), and BSS soundings. The first through fourth sequence 302-308 can conclude with the AP1 or AP2 receiving a CSI report having sounding results including one or more CSI feedback matrices V, depending on the sequence.

The first sequence 302 may include a first sequence AP1 NDPA 312a and a first sequence AP1 NDP 312b transmitted by AP1. The first sequence 302 may also include a first sequence intra-BSS sounding 302s that may include the first sequence AP1 NDP 312b transmitted from AP1 to the AP1 associated STAs, such as the STA1 and STA2 220a, 220b described in the foregoing with reference to FIG. 2. The first sequence 302 can also include a first sequence AP1 BFRP 312c and a first sequence intra-BSS CSI report 332d that is transmitted in response to the first sequence AP1 BFRP 312c.

The second sequence 304 may include a second sequence AP1 NDPA 314a and a second sequence AP2 NDP 324b. The second sequence 304 can also include a second sequence cross-BSS sounding 304s that may include the second sequence AP2 NDP 324b. The second sequence 304 can also include a second sequence AP1 BFRP 314c and a second sequence AP2 cross-BSS CSI report 334d sent to AP2 in response to the second sequence AP1 BFRP 314c.

Referring still to FIG. 3, the third sequence 306 may include a third sequence AP2 NDPA 326a and a third sequence AP2 NDP 326b. The third sequence 306 may also include a third sequence intra-BSS sounding 306s that may include the third sequence AP2 NDP 326b. The third sequence 306 can also include a third sequence AP2 BFRP 326c and a third sequence AP2 intra-BSS CSI report 346d that may be sent to AP2 in response to the third sequence AP2 BFRP 326c.

The fourth sequence 308 may include a fourth sequence AP2 NDPA 328a and a fourth sequence AP1 NDP 318b. The fourth sequence 308 can also include a fourth sequence cross-BSS sounding 308s that includes the fourth sequence AP1 NDP 318b. The fourth sequence 308 can also include a fourth sequence AP2 BFRP 328c and a fourth sequence AP2 cross-BSS CSI report 348d sent to AP1 in response to the fourth sequence AP2 BFRP 328c.

Independent SVD can be performed for each relevant channel matrix Hᵢⱼ. The channel matrix Hᵢⱼ may be for one of the intra-BSS channels 232 or the cross-BSS channels 234. For example, an SVD performed on the STA1-AP1 intra-BSS channel matrix H₁₁ and the STA1-AP2 cross-BSS channel matrix H₁₂ can respectively be denoted as svd(H₁₁) and svd(H₁₂). For this example, the SVD can be represented as follows:

$$svd ( {H}_{11} ) = {U}_{11} {S}_{11} {V}_{11}^{H} ; and \qquad Equation [ 2 ]$$

$$svd ( {H}_{12} ) = {U}_{12} {S}_{12} {V}_{12}^{H} . \qquad Equation [ 3 ]$$

In independent SVD with sequential sounding, channel matrices H₁₁, H₂₁ may be determined based on the first sequence intra-BSS sounding 302s. The first sequence intra-BSS CSI report 332d may be based on the SVD of the channel matrices H₁₁, H₂₁, which is indicated by the svd(H₁₁) and svd(H₂₁). The first sequence intra-BSS CSI report 332d accordingly may include decomposition matrices, such as a STA1-AP1 right singular matrix V₁₁, a STA1-AP1 singular value matrix S₁₁, a STA2-AP1 right singular matrix V₂₁, and/or a STA2-AP1 singular value matrix S₂₁.

Similarly, the channel matrices H₁₂, H₂₂ may be determined based on the second sequence cross-BSS sounding 304s. An SVD may be performed on the channel matrices H₁₂, H₂₂ as is indicated by the svd(H₁₂) and svd(H₂₂). The second sequence AP2 cross-BSS CSI report 334d may feedback a normalized STA1-AP2 right singular matrix V̅₁₂, a STA1-AP2 singular value matrix S₁₂, a normalized STA2-AP2 right singular matrix V̅₂₂, and/or a STA2-AP2 singular value matrix S₂₂.

Also in independent SVD with sequential sounding, channel matrices H₃₂, H₄₂ may be determined based on the third sequence intra-BSS sounding 306s. The third sequence AP2 intra-BSS CSI report 336d may be based on the SVD of the channel matrices H₃₂, H₄₂, which is indicated by the svd(H₃₂) and svd(H₄₂). The third sequence AP2 intra-BSS CSI report 336d accordingly may include decomposition matrices, such as a STA3-AP2 right singular matrix V₃₂, a STA3-AP2 singular value matrix S₃₂, a STA4-AP2 right singular matrix V₄₂, and/or a STA4-AP2 singular value matrix S₄₂.

Similarly, the channel matrices H₃₁, H₄₁ may be determined based on the fourth sequence cross-BSS sounding 308s. An SVD may be performed on the channel matrices H₃₁, H₄₁ as is indicated by the svd(H₃₁) and svd(H₄₁). The fourth sequence AP2 cross-BSS CSI report 338d may feedback a normalized STA3-AP1 singular value matrix V₃₁, a STA3-AP1 singular value matrix S₃₁, a normalized STA4-AP1 right singular matrix V₄₁, and a STA4-AP1 singular value matrix S₄₁.

Joint SVD with Joint Sounding in Co-BF

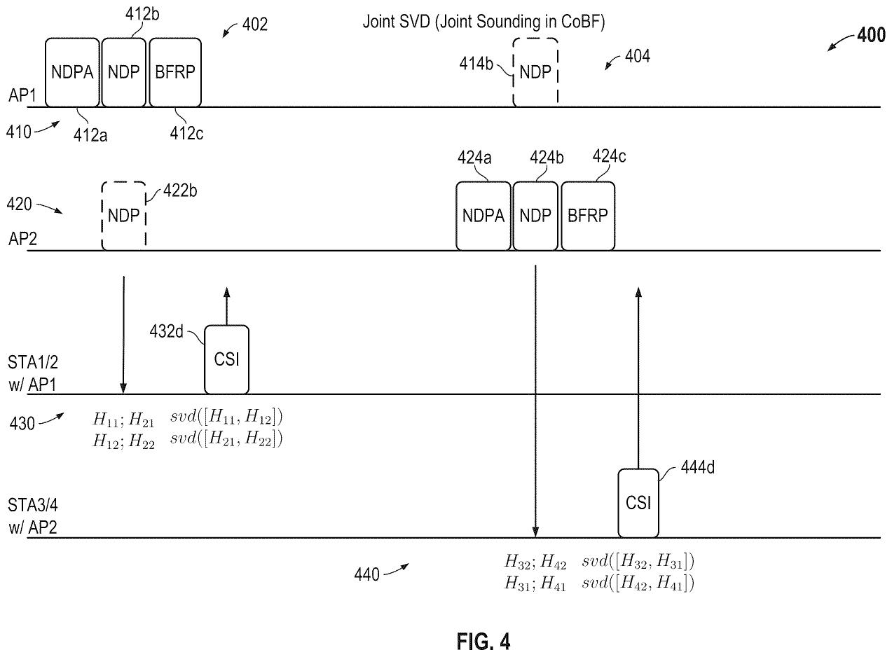

FIG. 4 is a sequence diagram 400 for joint SVD with joint sounding in Co-BFing.

Referring to FIG. 4, the sequence diagram 400 is for a separated SVD with joint sounding. The sequence diagram 400 is shown as including an AP1 sequence 410, an AP2 sequence 420, an AP1 associated STAs sequence 430, and an AP2 associated STAs sequence 440. The sequence diagram 400 may also include a first sequence 402 and a second sequence 404. The first and second sequence 402, 404 may begin with NDPAs transmitted by AP1 or AP2. The first and second sequence 402, 404 can also include NDPs and BFRPs transmitted from AP1 or AP2 to associated and/or non-associated STAs. The first and second sequence 402, 404 can further include CSI reports transmitted by STAs to APs in response to the BFRPs.

The first sequence 402 can include a first sequence AP1 NDPA 612a and a first sequence AP1 NDP 412b. The first sequence 402 may also include a first sequence AP2 NDP 422b transmitted by AP2. The first sequence AP1 and AP2 NDPs 412b, 422b may be transmitted to AP1 associated STAs, such as the STA1 and STA2 220a, 220b described in the foregoing with reference to FIG. 2. The first sequence 402 can also include a first sequence AP1 BFRP 412c and an AP1 associated STAs CSI report 432d that may be transmitted in response to the first sequence AP1 BFRP 412c.

Referring to FIG. 4, the second sequence 404 can include a second sequence AP2 NDPA 424a, a second sequence AP1 NDP 414a transmitted by AP1, and a second sequence AP2 NDP 424b transmitted by AP2. The second sequence AP1 NDP 414a and the second sequence AP2 NDP 424a may be received by the AP2 associated STAs, such as the STA3 and STA4 220c, 220d described above with reference to FIG. 2. The second sequence 404 can also include a second sequence AP2 BFRP and a second sequence AP2 associated STAs associated STAs 444d transmitted by the AP2 associated STAs.

Referring to the system 200 of FIG. 2, where the STA1 220a receives signals from the AP1 210a and the AP2 210b, joint SVD can be performed by evaluating svd([H₁₁, H₁₂]). With more particularity, a STA1 channel matrix H₁ can be defined as a concatenation of a STA1-AP1 channel matrix H₁₁ and a STA2-AP1 channel matrix H₁₂ as follows:

$${H}_{1} = [ {H}_{11} , {H}_{12} ] ; \qquad Equation [ 4 ]$$

where the STA1-AP1 channel matrix H₁₁ and the STA1-AP2 channel matrix H₁₂ each have dimensions of 4×8, and the STA1 channel matrix H₁ may have dimensions of 4×16. SVD may be performed on the STA1 channel matrix H₁ as follows:

$$svd ( {H}_{1} ) = {U}_{J , 1} {S}_{J , 1} {V}_{J , 1}^{H} = {U}_{J , 1} {S}_{J , 1} [ {V}_{J , 11}^{H} , {V}_{J , 12}^{H} ] ; \qquad Equation [ 5 ]$$

where the “J” subscript indicates a JSVD matrix. However, neither

$${V}_{J , 11}^{H} nor {V}_{J , 12}^{H}$$

are unitary. The STA1 left singular matrix U_{J,1}, the STA1 singular value matrix S_{J,1}, and the STA1 right singular matrix

$${V}_{J , 1}^{H}$$

may respectively have dimensions of 4×4, 4×4, and 16×4.

In addition, in joint SVD, the STA1 CSI feedback matrix V₁, the singular value matrix S₁, and a normalized STA1 CSI feedback matrix V̅₁ can be feedbacked to the BFer which here is the AP1 210a. The normalized STA1 CSI feedback matrix V₁ may expressed or formatted as follows:

$${V}_{J , 1} = ( \begin{matrix}{V}_{J , 11} \\ {V}_{J , 12}\end{matrix} ) = ( \begin{matrix}{V}_{J , 11}^{( 1 )} & {V}_{J , 11}^{( 0 )} \\ {V}_{J , 12}^{( 1 )} & {V}_{J , 12}^{( 0 )}\end{matrix} ) ; \qquad Equation [ 6 ]$$

where the (1) and (0) superscripts respectively indicate matrices to be used and to not be used in beamforming. The expression or format shown in Equation [6] may be referred to as a joint sounding/JSVD feedback.

With respect to the superscripts (1) and (0), for the sake of discussion, we can assume that the STA1 left singular matrix U_{J,1}, the STA1 singular value matrix S_{J,1}, and STA1 right singular matrix V_{J,1} may respectively have dimensions of 4×4, 4×4, and 4×16. It should be appreciated that the specific dimensions of the decomposition matrices may depend on the configuration of a system, such as the system 200 described with reference to FIG. 2, as characterized by the decomposition matrices.

To illustrate the selection of portions of a matrix, the following notation can be employed using the foregoing dimensions of the STA1 left singular matrix U_{J,1}, the STA1 singular value matrix S_{J,1}, and STA1 right singular matrix V_{J,1} as an example:

$${U}_{J , 1} = ( \begin{matrix}{U}_{J , 1} ( : , 1 , 2 ) & {U}_{J , 1} ( : , 3 : 4 )\end{matrix} ) = ( \begin{matrix}{U}_{J , 1}^{( 1 )} & {U}_{J , 1}^{( 0 )} ) ;\end{matrix} \qquad Equation [ 7 ]$$

$${S}_{J , 1} = ( \begin{matrix}{S}_{J , 1} ( 1 : 2 , 1 : 2 ) & {0}_{2 \times 2} \\ {0}_{2 \times 2} & {S}_{J , 1} ( 3 : 4 , 3 : 4 )\end{matrix} ) = ( \begin{matrix}{S}_{J , 1}^{( 1 )} & 0 \\ 0 & {S}_{J , 1}^{( 0 )}\end{matrix} ) ; \qquad Equation [ 8 ]$$

$$\begin{matrix}{V}_{J , 1} = ( \begin{matrix}{V}_{J , 1} ( 1 : 8 , 1 : 2 ) & {V}_{J , 1} ( 1 : 8 , 3 : 4 ) \\ {V}_{J , 1} ( 9 : 16 , 1 : 2 ) & {V}_{J , 1} ( 9 : 16 , 3 : 4 )\end{matrix} ) \\ = ( \begin{matrix}{V}_{J , 11}^{( 1 )} & {V}_{J , 11}^{( 0 )} \\ {V}_{J , 12}^{( 1 )} & {V}_{J , 12}^{( 0 )}\end{matrix} ) \\ = ( \begin{matrix}{V}_{J , 1}^{( 1 )} & {V}_{J , 1}^{( 0 )}\end{matrix} ) \\ = ( \begin{matrix}{V}_{J , 11} \\ {V}_{J , 22}\end{matrix} ) .\end{matrix} \qquad Equation [ 9 ]$$

The notation in the parenthesis of “r:r, c:c” employs indexes r and c to define a submatrix of a given decomposition matrix. The notation “r_{f}:rₗ, c_{f}:cₗ” means a submatrix from a first indexed row r_{f} to a last indexed row r₁ and a first indexed column c_{f} and a last indexed column cₗ of a matrix. By way of illustration, a used joint STA1-AP1 right singular submatrix

$${V}_{J , 11}^{( 1 )}$$

can be defined as follows:

$${V}_{J , 11}^{( 1 )} = {V}_{J , 1} ( 1 : 8 , 1 : 2 ) ; \qquad Equation [ 10 ]$$

where rows 1 to 8 and columns 1 and 2 are selected from the joint STA1 right singular matrix V_{J,1}.

Referring to the STA1 right singular matrix V_{J,1}, rows 1 to 8 may be a joint STA1-AP1 right singular submatrix V_{J,11} and rows 9 through 16 might be a joint STA1-AP2 right singular submatrix V_{J,12}. In addition, columns 1 and 2 may be a used joint STA1 right singular submatrix

$${V}_{J , 1}^{( 1 )}$$

and columns 3 and 4 may be an unused joint STA1 right singular submatrix

$${V}_{J , 1}^{( 0 )} .$$

In a joint sounding JSVD/SSVD feedback a normalized joint STA1 right singular matrix V̅_{J,1} and a joint STA1 singular value matrix S_{J,1} may be sent by the STA1.
Separated SVD with Sequential Sounding

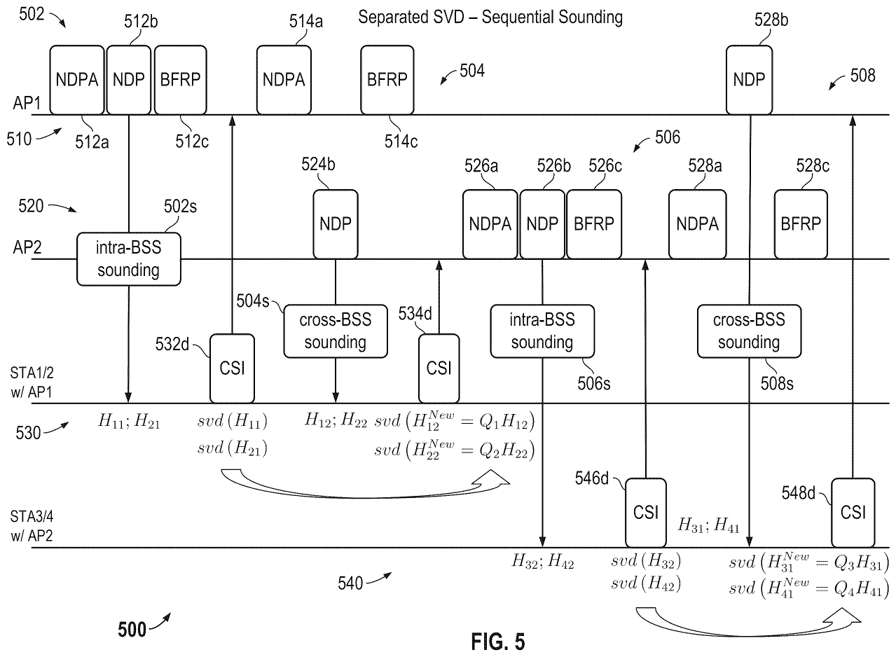

FIG. 5 is a sequence diagram 500 for separated SVD with sequential sounding.

Referring to FIG. 5, the sequence diagram 500 is for a separated SVD with sequential sounding. The sequence diagram 500 is shown as including an AP1 sequence 510, an AP2 sequence 520, an AP1 associated STAs sequence 530, and an AP2 associated STAs sequence 540. The sequence diagram 500 may also include a first sequence 502, a second sequence 504, a third sequence 506, and a fourth sequence 508. The first through fourth sequence 502-508 may begin with an NDPA although any suitable initiating sequence step may be employed. The first through fourth sequence 502-508 may also include NDPs, CSI reports, BFRPs, and BSS soundings. The first through fourth sequence 502-508 can conclude with the AP1 or AP2 receiving a CSI report having sounding feedback based on a right singular matrix H or a new right singular matrix H^{New}, depending on the sequence.

The first sequence 502 may include a first sequence AP1 NDPA 512a and a first sequence AP1 NDP 512b transmitted by AP1. The first sequence 502 may also include a first sequence AP1 cross-BSS sounding 502s that may include the first sequence AP1 NDP 512b transmitted from AP1 to the AP1 associated STAs, such as the STA1 and STA2 220a, 220b described above with reference to FIG. 2. The first sequence 502 can also include a first sequence AP1 BFRP 512c and a first sequence AP1 associated STAs CSI report 432d that is transmitted in response to the first sequence AP1 BFRP 512c.

The second sequence 504 may include a second sequence AP1 NDPA 514a and a second sequence AP2 NDP 524b. The second sequence 504 can also include a second sequence cross-BSS sounding 504s that may include the second sequence AP2 NDP 524b. The second sequence 504 can also include a second sequence AP1 BFRP 514c and a second sequence AP1 associated cross-BSS CSI report 534d sent to AP2 in response to the second sequence AP1 BFRP 514c.

Referring still to FIG. 5, the third sequence 506 may include a third sequence AP2 NDPA 526a and a third sequence AP2 NDP 526b. The third sequence 506 may also include a third sequence intra-BSS sounding 406s that may include the third sequence AP2 NDP 526b. The third sequence 406 can also include a third sequence AP2 BFRP 526c and a third sequence AP2 intra-BSS CSI report 446d that may be sent to AP2 in response to the third sequence AP2 BFRP 526c.

The fourth sequence 508 may include a fourth sequence AP2 NDPA 528a and a fourth sequence AP1 NDP 518b. The fourth sequence 408 can also include a fourth sequence cross-BSS sounding 508s that includes the fourth sequence AP1 NDP 518b. The fourth sequence 508 can also include a fourth sequence AP2 BFRP 528c and a fourth sequence AP2 cross-BSS CSI report 448d sent to AP1 in response to the fourth sequence AP2 BFRP 528c.

In general indexed notation, a SVD of a channel matrix Hᵢⱼ for an i-th STA and a j-th AP can be represented as:

$$svd ( {H}_{i j} ) = ( \begin{matrix}{U}_{ij}^{( 1 )} & {U}_{ij}^{( 0 )}\end{matrix} ) ( \begin{matrix}{S}_{ij}^{( 1 )} & 0 \\ 0 & {S}_{ij}^{( 0 )}\end{matrix} ) {( \begin{matrix}{V}_{ij}^{( 1 )} & {V}_{ij}^{( 0 )}\end{matrix} )}^{H} ; \qquad Equation [ 11 ]$$

where, for the system 200 described with reference to FIG. 2, ij={11, 21, 32, 42}. The SVD shown in Equation [11] may be used in intra-BSS sounding. The decomposition matrices U, S, V may respectively

The cross-BSS separated SVD may be determined according to the following:

$$svd ( {H}_{ij}^{New} ) = {U}_{ij}^{New} {{S}_{ij}^{New} ( {V}_{ij}^{New} )}^{H} . \qquad Equation [ 12 ]$$

The superscripts of (1) indicate columns to be used in beamforming and a superscript of (0) indicates columns not to be used in beamforming. As will be explained in more detail in the following, STA processing matrices Qᵢ can be used with cross-BSS channel matrices to determine a new cross-BSS sounding result.

For example, with reference to FIG. 2, in separated SVD, SVD can be performed on intra-BSS channel matrices such as the STA1-AP1 channel matrix H₁₁ or the STA2-AP1 channel matrix H₂₁. The results of these SVDs can be feedbacked to the associated AP which, with reference to FIG. 2, may be the AP1 210a. In addition, the results of the SVD on the intra-BSS channel matrices can also be used to perform SVD on non-associated STA channel matrices, in contrast to the independent SVD described in the foregoing. In addition, in contrast to the joint SVD feedbacked STA1-AP1 right singular matrix V₁₁, the feedbacked results from the separated SVD can be used for SU-MIMO.

By way of illustration, an SVD may be performed on the STA1-AP1 channel matrix H₁₁ as follows to determine a STA1-AP1 decomposition matrix U₁₁ as follows:

$$svd ( {H}_{11} ) \to {U}_{11} . \qquad Equation [ 13 ]$$

A Hermitian transpose of the STA1-AP1 left singular matrix U₁₁ can be used to determine a STA1 processing matrix Q₁ as follows:

$${Q}_{1} = {( {U}_{11}^{( 1 )} )}^{H} . \qquad Equation [ 14 ]$$

Note that the superscript (1) may indicate columns that are to be used in beamforming or processing by the STA1. The STA1 processing matrix Q₁ may strictly be based on (e.g., strictly comprise) a submatrix of the STA1-AP1 left singular matrix U₁₁. For example, with reference to the above described example of a joint STA1 channel matrix H₁ having dimensions of 4×16 and matrix indexing notation, the STA1 processing matrix Q₁ may comprise the first and second column of the STA1-AP1 left singular matrix

$${( {U}_{11}^{( 1 )} )}^{H} = {( ( {U}_{11} ( : , 1 \text{:} 2 ) ) )}^{H} .$$

Accordingly, the STA1 processing matrix Q₁ may have dimensions of 2×4, although any suitable submatrix dimensions may be employed.

The STA1 processing matrix Q₁ can then be used to perform SVD on an STA1-AP2 cross-BSS channel matrix H₁₂ as follows:

$$svd ( {H}_{12}^{New} = {Q}_{1} {H}_{12} ) = {U}_{12}^{New} {{S}_{12}^{New} ( {V}_{12}^{New} )}^{H} . \qquad Equation [ 15 ]$$

With reference to the STA1 channel matrix H₁ having dimensions of 2×16. The dimensions of the new STA1-AP2 channel matrix

$${H}_{12}^{New} = {Q}_{1} {H}_{12}$$

may be 2×8. The new STA1-AP2 decomposition matric

$${U}_{12}^{New} , {S}_{12}^{New} , {V}_{12}^{New}$$

may respectively have dimensions of 2×2, 2×2, 2×8. The results of the SVD on the Q₁H₁₂ can be feedbacked. For example, the normal MU-MIMO results may be feedbacked: the intra-BSS and cross-BSS CSI feedback matrices comprising the STA1-AP1 and new STA1-AP2 right singular matrices V₁₁,

$${V}_{12}^{New} .$$

It should also be appreciated that normalized right singular matrices V̅₁₁,

$${\overline{V}}_{12}^{New}$$

may alternatively be feedbacked.

Referring to FIG. 5 for a more complete discussion, in separated SVD with sequential sounding, STA1 and STA2 channel matrices H₁₁, H₂₁ may be determined based on the first sequence intra-BSS sounding 502s. The first sequence AP1 associated STAs CSI report 432d may be based on the SVD of the STA1 and STA2 channel matrices H₁₁, H₂₁, which is indicated by the svd(H₁₁) and svd(H₂₁). The first sequence AP1 intra-BSS CSI report 532d accordingly may include decomposition matrices, such as a STA1-AP1 right singular matrix V₁₁, a STA1-AP1 singular value matrix S₁₁, a STA2-AP1 right singular matrix V₂₁, and/or a STA2-AP1 singular value matrix S₂₁.

The SVD of the STA1 and STA2 channel matrices H₁₁, H₂₁ can also determine a STA1-AP1 left singular matrix U₁₁ in accordance with the above Equation [13]. In addition, the STA1 processing matrix Q₁ may also be determined according to the foregoing Equation [14]. The STA2 processing matrix Q₂ can similarly be determined as is indicated by the arrow from the svd(H₁₁) and the svd(H₂₁) to the STA1 and STA2 processing matrices Q₁, Q₂. The SVD of the STA1 and STA2 channel matrices H₁₁, H₂₁ can also provide the singular value matrices S₁₁, S₂₁, S₃₂, S₄₂ and the right singular matrices V₁₁, V₂₁, V₃₂, V₄₂.

SVD can be performed on a new STA1-AP2 channel matrix

$${H}_{12}^{New}$$

and a new STA2-AP2 channel matrix

$${H}_{22}^{New} .$$

For example, the new STA1-AP2 channel matrix

$${H}_{12}^{New}$$

can be defined as

$${H}_{12}^{New} = {Q}_{1} {H}_{12}$$

and the new STA2-AP2 channel matrix

$${H}_{22}^{New}$$

can be defined as

$${H}_{22}^{New} = {Q}_{2} {H}_{22} .$$

Accordingly, SVD may be performed as follows:

$$svd ( {H}_{12}^{New} = {Q}_{1} {H}_{12} ) and the svd ( {H}_{22}^{New} = {Q}_{2} {H}_{22} )$$

according to the foregoing Equation [15] to determine new singular value matrices

$${S}_{12}^{New} , {S}_{22}^{New} , {S}_{31}^{New} , {S}_{41}^{New}$$

and new right singular matrices

$${V}_{12}^{New} , {V}_{22}^{New} , {V}_{31}^{New} , {V}_{41}^{New} .$$

The description of FIG. 5 pertains to performing a separated SVD using sequential sounding. The following describes an exemplary separated SVD using joint sounding.

Separated SVD with Joint Sounding

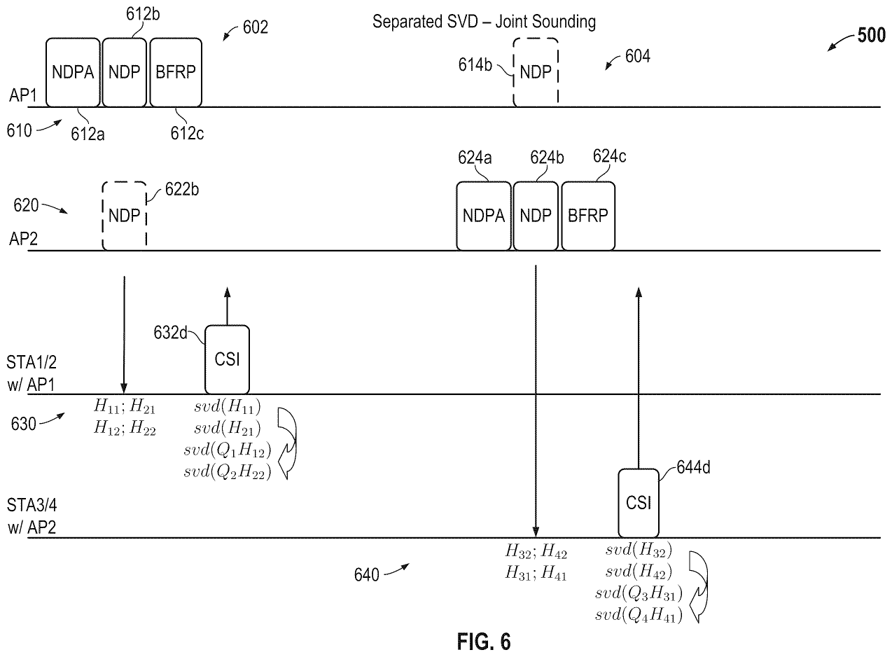

FIG. 6 is a sequence diagram 600 for separated SVD with joint sounding.

Referring to FIG. 6, the sequence diagram 600 is for a separated SVD with joint sounding. The sequence diagram 600 is shown as including an AP1 sequence 610, an AP2 sequence 620, an AP1 associated STAs sequence 630, and an AP2 associated STAs sequence 640. The sequence diagram 600 may also include a first sequence 602 and a second sequence 604. The first and second sequence 602, 604 may begin with NDPAs transmitted by AP1 or AP2. The first and second sequence 602, 604 can also include NDPs and BFRPs transmitted from AP1 or AP2 to associated and/or non-associated STAs. The first and second sequence 602, 604 can further include CSI reports transmitted by STAs to APs in response to the BFRPs.

The first sequence 602 can include a first sequence AP1 NDPA 612a and a first sequence AP1 NDP 612b. The first sequence 602 may also include a first sequence AP2 NDP 622b transmitted by AP2. The first sequence AP1 and AP2 NDPs 612b, 622b may be transmitted to AP1 associated STAs, such as the STA1s and STA2 220a, 220b described in the foregoing with reference to FIG. 2. The first sequence 602 can also include a first sequence AP1 BFRP 612c and an AP1 associated STAs CSI report 632d that may be transmitted in response to the first sequence AP1 BFRP 612c.

Referring to FIG. 6, the second sequence 604 can include a second sequence AP2 NDPA 624a, a second sequence AP1 NDP 614a transmitted by AP1, and a second sequence AP2 NDP 624b transmitted by AP2. The second sequence AP1 NDP 614a and the second sequence AP2 NDP 624a may be received by the AP2 associated STAs, such as the STA3 and STA4 220c, 220d described above with reference to FIG. 2. The second sequence 604 can also include a second sequence AP2 BFRP and a second sequence AP2 associated STAs CSI report 644d transmitted by an AP2 associated STA.

Referring to FIG. 6, the first sequence AP1 NDP 612b received by STA1 and/or STA2 can be used to determine a STA1-AP1 channel matrix H₁₁ and a STA2-AP1 channel matrix H₂₁. Similarly, the first sequence AP2 NDP 622b received by STA1 and/or STA2 can be used to determine an STA1-AP2 channel matrix H₁₂ and an STA2-AP2 channel matrix H₂₂. The first sequence AP1 NDP 612b and the first sequence AP2 NDP 522b can be received simultaneously. SVD can be performed on the STA1-AP1 channel matrix H₁₁ and the STA2-AP1 channel matrix H₂₁ to determine the right singular matrices V as described above with reference to Equation [2].

In the case of separated SVD feedback from joint sounding, an existing joint SVD can be reused. For example, referring to FIG. 2, the STA1 220a feedback may be:

$$\{ {S}_{11}^{( 1 )} , {V}_{11}^{( 1 )} , {V}_{12}^{New} \} . \qquad Equation [ 16 ]$$

Note that a full dimension intra-BSS sounding feedback may include {S₁₁, V₁₁}, {S₂₁, V₂₁}, {S₃₂, V₃₂}, and {S₄₂, V₄₂}, which may be sufficient for reuse in MU-MIMO and SU-MIMO.

Accordingly, a full dimension feedback, including intra-BSS sounding and cross-BSS sounding, for all of the stations may be as summarized in Table 1.

TABLE 1
Feedback for the STAs

| Station | Feedback |
|---|---|
| STA1 | $\{ {S}_{11} , ( \frac{1}{\sqrt{2}} [ \begin{matrix}{V}_{11}^{( 1 )} \\ {V}_{12}^{new}\end{matrix} ] , [ \begin{matrix}{V}_{11}^{( 0 )} \\ 0\end{matrix} ] ) \} \qquad Eq . [ 17 ]$ |
| STA2 | $\{ {S}_{21} , ( \frac{1}{\sqrt{2}} [ \begin{matrix}{V}_{21}^{( 1 )} \\ {V}_{22}^{new}\end{matrix} ] , [ \begin{matrix}{V}_{21}^{( 0 )} \\ 0\end{matrix} ] ) \} \qquad Eq . [ 18 ]$ |
| STA3 | $\{ {S}_{31} , ( \frac{1}{\sqrt{2}} [ \begin{matrix}{V}_{32}^{( 1 )} \\ {V}_{31}^{new}\end{matrix} ] , [ \begin{matrix}{V}_{32}^{( 0 )} \\ 0\end{matrix} ] ) \} \qquad Eq . [ 19 ]$ |
| STA4 | $\{ {S}_{41} , ( \frac{1}{\sqrt{2}} [ \begin{matrix}{V}_{42}^{( I )} \\ {V}_{41}^{new}\end{matrix} ] , [ \begin{matrix}{V}_{42}^{( 0 )} \\ 0\end{matrix} ] ) \} \qquad Eq . [ 20 ]$ |

The joint sounding from JSVD feedback formats shown in Table 1 are exemplary. Other feedback formats may be employed.

With respect to whether the feedback can be used for MU-MIMO and SU-MIMO, the STA1 CSI feedback matrix:

$$Equation [ 21 ]$$

$${V}_{J , 1} = ( \begin{matrix}{V}_{J , 11}^{( 1 )} & {V}_{J , 11}^{( 0 )} \\ {V}_{J , 12}^{( 1 )} & {V}_{J , 12}^{( 0 )}\end{matrix} ) = ( \frac{1}{\sqrt{2}} [ \begin{matrix}{V}_{11}^{( 1 )} \\ {V}_{12}^{New}\end{matrix} ] , [ \begin{matrix}{V}_{11}^{( 0 )} \\ 0\end{matrix} ] ) = ( \begin{matrix}{V}_{11}^{( 1 )} / \sqrt{2} & {V}_{11}^{( 0 )} \\ {V}_{12}^{New} / \sqrt{2} & 0\end{matrix} ) ,$$

meets the definition of a unitary matrix:

$${V}_{1}^{H} {V}_{1} = I .$$

As can be appreciated form comparison of the left-hand side and the right-hand side of Equation [21], the following relationships can be derived:

$${V}_{J , 11}^{( 1 )} = \frac{1}{\sqrt{2}} {V}_{11}^{( 1 )} , {V}_{J , 12}^{( 1 )} = \frac{1}{\sqrt{2}} {V}_{12}^{New} , {V}_{J , 11}^{( 0 )} = {V}_{11}^{( 0 )} , and {V}_{J , 12}^{( 0 )} = 0 .$$

In general, for Equation [21], V̅_{J,1}≠V_{J,1}. The format or expression shown in Equation [21] may be referred to as a joint sounding/SSVD feedback form.

As can be appreciated from the foregoing discussion and with reference to the system 200 of FIG. 2, the STA1-AP1 intra-BSS channel matrix H₁₁ and a STA1-AP2 cross-BSS channel matrix H₁₂ can be determined using joint sounding in Co-BFing. Additionally, the feedback may include, for example, a normalized STA1 CSI feedback matrix V₁ as follows:

$${\overline{V}}_{1} = ( \begin{matrix}{\tilde{V}}_{11}^{( 0 )} / \sqrt{2} & {\tilde{V}}_{11}^{( 1 )} \\ {\overline{V}}_{12}^{New} / \sqrt{2} & 0\end{matrix} ) ; \qquad Equation [ 22 ]$$

where the (1) and (0) superscripts respectively indicate matrices to be used and not used for beamforming. The format or expression shown in Equation [22] may be the results of a normalized joint sounding/SSVD feedback. Accordingly, the result of Equation [22] may be referred to as a normalized-regular STA1 CSI feedback matrix V₁. The normalized-regular STA1 CSI feedback matrix V₁ of Equation [22] may be a unitary matrix.

### Optimal SVD Feedback

As described above, the channel matrices H may be noisy and channel smoothing filtering can be used to reduce such noise in the channel matrices H. Generally, such filtering may not be employed with beamformed channels H·V. An optimal right singular matrix \tilde{V} can be derived to enable the use of channel smoothing filtering of beamformed channels H·\tilde{V}. However, an optimal right singular matrix \tilde{V} may not be feedbacked from a STA (e.g., beamformee) to an AP (e.g., beamformer) due to, for example, constraints imposed by prior standards to feedback mechanisms, etc. An optimal right singular matrix \tilde{V} may be feedbacked using the joint sounding/JSVD feedback of Equations [6], [8], and [9] or the normalized joint sounding/SSVD feedback of Equation [21].

For example, the normalized STA1 CSI feedback matrix V̅₁ shown in above Equation [22] may be employed using joint sounding/JSVD feedback. The normalized STA1-AP1 right singular matrix V̅₁₁ used for Equation [22] may be replaced by the optimal STA1-AP1 right singular matrix \tilde{V}₁₁. Accordingly, a feedback having the form and content according to the following:

$$Equation [ 23 ]$$

$${\overline{V}}_{J , 1} = ( \begin{matrix}{V}_{J , 11}^{( 1 )} & {V}_{J , 11}^{( 0 )} \\ {V}_{J , 12}^{( 1 )} & {V}_{J , 12}^{( 0 )}\end{matrix} ) = ( \frac{1}{\sqrt{2}} [ \begin{matrix}{\tilde{V}}_{11}^{( 1 )} \\ {\overline{V}}_{12}^{New}\end{matrix} ] , [ \begin{matrix}{\tilde{V}}_{11}^{( 0 )} \\ 0\end{matrix} ] ) = ( \begin{matrix}{\tilde{V}}_{11}^{( 0 )} / \sqrt{2} & {\tilde{V}}_{11}^{( 1 )} \\ {\overline{V}}_{12}^{New} / \sqrt{2} & 0\end{matrix} ) ;$$

may employed, where the (1) and (0) superscripts respectively indicate submatrices to be used and not used for beamforming. As can be appreciated form comparison of the left-hand side and the right-hand side of Equation [23], the following relationships can be derived:

$${V}_{J , 11}^{( 1 )} = \frac{1}{\sqrt{2}} {\tilde{V}}_{11}^{( 1 )} , {V}_{J , 12}^{( 1 )} = \frac{1}{\sqrt{2}} {\overline{V}}_{12}^{New} , {V}_{J , 11}^{( 0 )} = {\tilde{V}}_{11}^{( 0 )} , and {V}_{J , 12}^{( 0 )} = 0.$$

It is evident that V̅_{J,1}=V_{J,1} for Equation [23]. The format or expression shown in Equation [23] may be referred to as a “normalized-optimal CSI feedback matrix V̅₁” although any suitable term may be employed.

The normalized-optimal STA1 CSI feedback matrix V̅₁ of Equation [23] may be a unitary matrix. It should also be appreciated that the optimal STA1-AP1 right singular matrix

$${\tilde{V}}_{11} = [ {\tilde{V}}_{11}^{( 1 )} , {\tilde{V}}_{11}^{( 0 )} ]$$

and the normalized new STA1-AP2 right singular matrix

$${\overline{V}}_{12}^{New}$$

are unitary. The “zero” in Equations [8] and [17] through [22] represents a matrix of all zeros or a null matrix or suitable dimensions. The feedback may include a STA1-AP1 singular value matrix S₁₁ determined according to Equations [11] and [12] in a form expressed as:

$$\{ {S}_{11} , {\overline{V}}_{J , 1} \} ; \qquad Equation [ 24 ]$$

which may be congruent with the form shown in Equation [16]. As noted above, the normalized-optimal STA1 right singular matrix V̅_{J,1} includes the optimal STA1-AP1 right singular matrix \tilde{V}₁₁.

As to the joint sounding JSVD feedback mechanism described above with reference to Equation [6] being reused or packed with an optimal STA1-AP1 right singular matrix \tilde{V}₁₁, the following relationship illustrating non-uniqueness may be noted based on the foregoing discussion:

$$svd ( {H}_{11} ) = {U}_{11} {S}_{11} {V}_{11}^{H} = {\overline{U}}_{11} {S}_{11} {\overline{V}}_{11}^{H} = {\overline{U}}_{11} {S}_{11} {\tilde{V}}_{11}^{H} . \qquad Equation [ 25 ]$$

Accordingly, with reference to the foregoing Equations [6], [21], and [23], we can note that the following relationship may be employed:

$${V}_{J , 1} = ( \begin{matrix}{V}_{J , 11}^{( 1 )} & {V}_{J , 11}^{( 0 )} \\ {V}_{J , 12}^{( 1 )} & {V}_{J , 22}^{( 0 )}\end{matrix} ) = ( \frac{1}{\sqrt{2}} [ \begin{matrix}{\tilde{V}}_{11}^{( 1 )} \\ {\overline{V}}_{12}^{New}\end{matrix} ] , [ \begin{matrix}{\tilde{V}}_{11}^{( 0 )} \\ 0\end{matrix} ] ) . \qquad Equation [ 26 ]$$

As can be appreciated from the foregoing description of FIGS. 4 through 6, a feedback including a normalized-optimal STA1 CSI feedback matrix V̅_{J,1} may be part of a Co-BF and feedback procedure, as is explained in more detail in the following.

### Exemplary Co-BF and Feedback Procedure

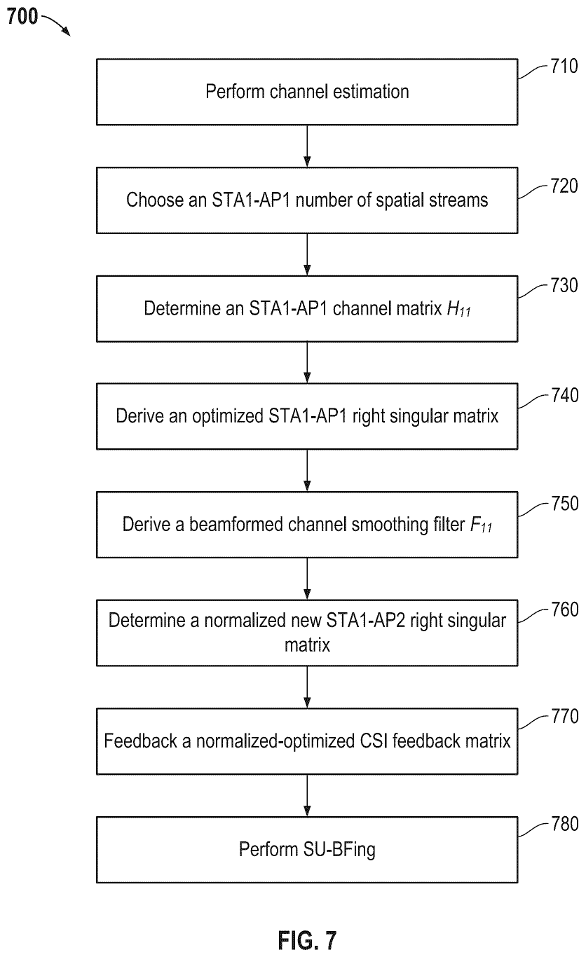

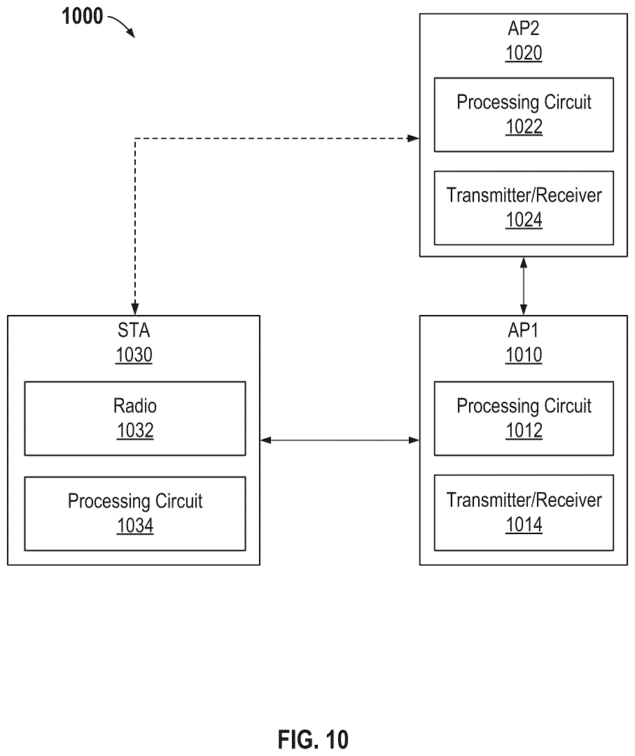

FIG. 7 is a method 700 for optimal SVD based beamforming. The method 700 may be performed by the system 200 and the system 1000 respectively described with reference to FIGS. 2 and 10.

Referring to FIGS. 7 and 2, the method 700 may perform a channel estimation to determine a STA1-AP1 channel matrix H₁₁ and a STA1-AP2 channel matrix H₁₂ in step 710. In step 720, the method 700 may choose an STA1-AP1 number of spatial streams (NSS₁₁). The method 700, at step 730, can determine an STA1-AP1 channel matrix H₁₁. The method 700 can derive an optimal STA1-AP1 right singular matrix \tilde{V}₁₁ in step 740. In step 750, the method 700 can derive a beamformed channel smoothing filter F₁₁. The method 700 can determine a normalized new STA1-AP2 right singular matrix

$${\overline{V}}_{12}^{New}$$

in step 760 and feedback a normalized-optimal CSI feedback matrix V̅₁ in steps 770. In step 780, the method 700 can perform SU-BFing.

With reference to step 710, the channel estimation may be a high accuracy channel estimation from sounding. High accuracy channel estimation from sounding may be a standard defined channel estimation at a sounding phase having high accuracy. In step 720, the NSS₁₁ may be a maximum number of data streams to STA1 when using Co-BFing.

At step 730, the STA1-AP1 channel matrix H₁₁ may be an intra-BSS channel matrix and thus may alternatively be referred to as the STA1-AP1 intra-BSS channel matrix H₁₁. The SVD decomposition according to Equation [7] may result in a STA1-AP1 right singular strict usable submatrix

$${V}_{11}^{( 1 )}$$

and an STA1-AP1 right singular non-usable submatrix

$${V}_{11}^{( 0 )} .$$

With reference to Equation [7], a rank of the left and right singular matrices U and V may be as follows:

$$rank ( {U}_{11}^{( 1 )} ) = rank ( {V}_{11}^{( 1 )} ) = {NSS}_{11} \leq ( {U}_{11} ) - 1 ; \qquad Equation [ 26 ]$$

where the superscripts of (1) may indicate a strict usable submatrix of the STA1-AP1 left singular matrix U₁₁ or the STA1-AP1 right singular matrix V₁₁. The strict usable submatrix may be defined as all the rows and columns 0 to m, where m may need to be less than the number of columns of the STA1-AP1 left singular matrix U₁₁ or the STA1-AP1 right singular matrix V₁₁.

With reference to step 740, the optimal STA1-AP1 right singular matrix \tilde{V}₁₁ may be determined based on a STA1-AP1 right singular matrix V₁₁ according to a predefined optimization criteria. In step 750, the method 700 can derive the beamformed channel smoothing filter F₁₁ for a beamformed channel H₁₁·\tilde{V}₁₁. As to step 760, the method 700 can determine a normalized new STA1-AP2 right singular matrix

$${\overline{V}}_{12}^{New}$$

based on the new STA1-AP2 channel matrix

$${H}_{12}^{New}$$

as described with reference to FIGS. 5 and 6. In step 770, a normalized-optimal STA1 CSI feedback matrix V̅₁ may be formed based on the normalized new STA1-AP2 right singular matrix

$${\overline{V}}_{12}^{New}$$

and the optimal STA1-AP2 right singular matrix \tilde{V}₁₁ according to Equation [14]. With reference to step 780, the method 700 the STA1-AP1 singular value matrix S₁₁ and the normalized-optimal STA1 CSI feedback matrix V̅₁ may be feedbacked in the form described with reference to Equation [15].

As to step 790, the SU-BFing may occur when AP1 (e.g., beamformer) sends data to the STA1 (e.g., beamformee). The AP1 may indicate to STA1 that channel smoothing filtering should be enabled in the STA1. A raw channel estimation may be performed in the STA1 to obtain:

$${\hat{H}}_{BF , 11} = {H}_{BF , 11} + n . \qquad Equation [ 27 ]$$

The step 790 may also perform a smoothing filtering on Ĥ_{BF,11} as expressing in the following:

$${\tilde{\hat{H}}}_{BF , 11} = {F}_{11} [ {\hat{H}}_{BF , 11} ] ; \qquad Equation [ 28 ]$$

to obtain higher accuracy than the Ĥ_{BF,11}. SU-BFing receiving by the STA1 may be performed in any suitable matter.

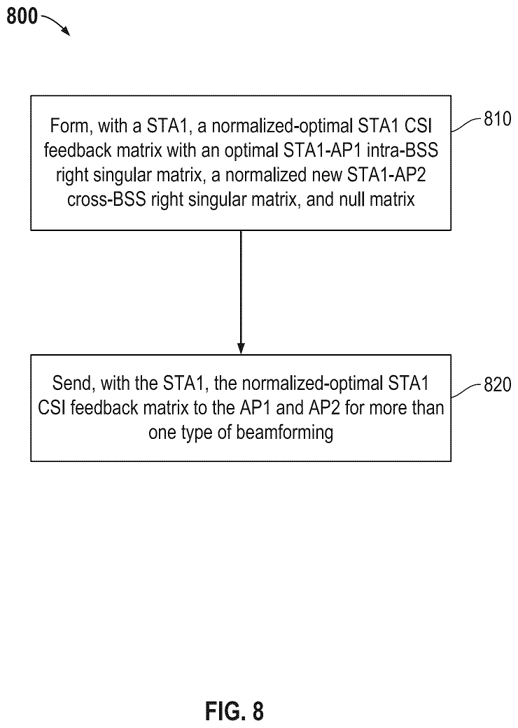

FIG. 8 is a method 800 for optimal SVD based beamforming.

Referring to FIG. 8, the method 800 includes, in step 810, forming, with an STA1, a normalized-optimal STA1 CSI feedback matrix V̅₁ with an optimal STA1-AP1 intra-BSS right singular matrix \tilde{V}₁₁, a normalized new STA1-AP2 cross-BSS right singular matrix

$${\overline{V}}_{12}^{new} ,$$

and a null matrix. The method 800 also includes sending, with the STA1, the normalized-optimal STA1 CSI feedback matrix V̅₁ to the AP1 and AP2 for more than one type of beamforming.

For example, the normalized-optimal STA1 CSI feedback matrix V̅₁ may have a form equivalent to a normalized-regular STA1 CSI feedback matrix V̅₁ including a normalized STA1-AP1 intra-BSS right singular matrix V̅₁₁. The STA1 may send the normalized-optimal STA1 CSI feedback matrix V̅₁ to the AP1 via a joint feedback mechanism. The STA1 may send the normalized-optimal STA1 CSI feedback matrix V̅₁ to the AP1 for SU-MIMO beamforming by the AP1.

The method 800 can further comprise determining, with the AP1, if the normalized-optimal STA1 CSI feedback matrix V̅₁ is formed using one of a default joint separated singular value decomposition (SVD), a regular separated SVD, or an optimal separated SVD. The method 800 determining, with the AP1, if the normalized-optimal STA1 CSI feedback matrix V̅₁ is formed using one of the default joint SVD, a regular separated SVD, or an optimal separated SVD is based on one of a structure of the normalized-optimal STA1 CSI feedback matrix V̅₁ or an indication transmitted by the STA1 to the AP1.

The method 800 may further comprise transmitting, by the STA1, to the AP1 at least one of an SVD calculation indication that the CSI STA1 feedback matrix V̅₁ is determined using one of a default SVD or a regular separated SVD, or an optimal separated SVD or a feedback type indication that the normalized-optimal STA1 CSI feedback matrix V̅₁ is determined based on one of a regular separated SVD or an optimal separated SVD. The method 800 can further include extracting, with the AP1, the optimal STA1-AP1 intra-BSS right singular matrix \tilde{V}₁₁ from the normalized-optimal STA1 CSI feedback matrix V̅₁.

The method 800 may also include performing, with the AP1, an intra-BSS sounding of the STA1 to obtain the STA1-AP1 intra-BSS right singular matrix V₁₁, determining, with the STA1, an optimal STA1-AP1 intra-BSS right singular matrix \tilde{V}₁₁ based on the STA1-AP1 intra-BSS right singular matrix V₁₁ and an optimization criterion, and performing, with the AP2, a cross-BSS sounding of the STA1 to determine a normalized new STA1-AP2 cross-BSS right singular matrix

$${\overline{V}}_{12}^{New} .$$

The method 800 can also include performing, with the AP2, the cross-BSS sounding of the STA1 to determine the normalized new STA1-AP2 cross-BSS right singular matrix

$${\overline{V}}_{12}^{New}$$

by performing, with the AP2, the cross-BSS sounding of the STA1, determining, with the STA1, an STA1-AP2 cross-BSS channel matrix H₁₂ based on the cross-BSS sounding of the STA1 by the AP2, and determining, with the STA1, a new STA1-AP2 cross-BSS channel matrix

$${H}_{12}^{New}$$

based on the STA1-AP2 cross-BSS channel matrix H₁₂ and an STA1 processing matrix Q₁ determined based on a Hermitian transpose of the STA1-AP1 intra-BSS left singular matrix U₁₁, and determining, with the STA1, the normalized new STA1-AP2 cross-BSS right singular matrix

$${\overline{V}}_{12}^{New}$$

based on the new STA1-AP2 cross-BSS channel matrix

$${H}_{12}^{New} .$$

The method 800 may further comprise transmitting, with the AP1, instructions to the STA1 to perform one of a default joint SVD, regular separated SVD, and the optimal separated SVD to determine the normalized-optimal AP1 CSI feedback matrix V̅₁.

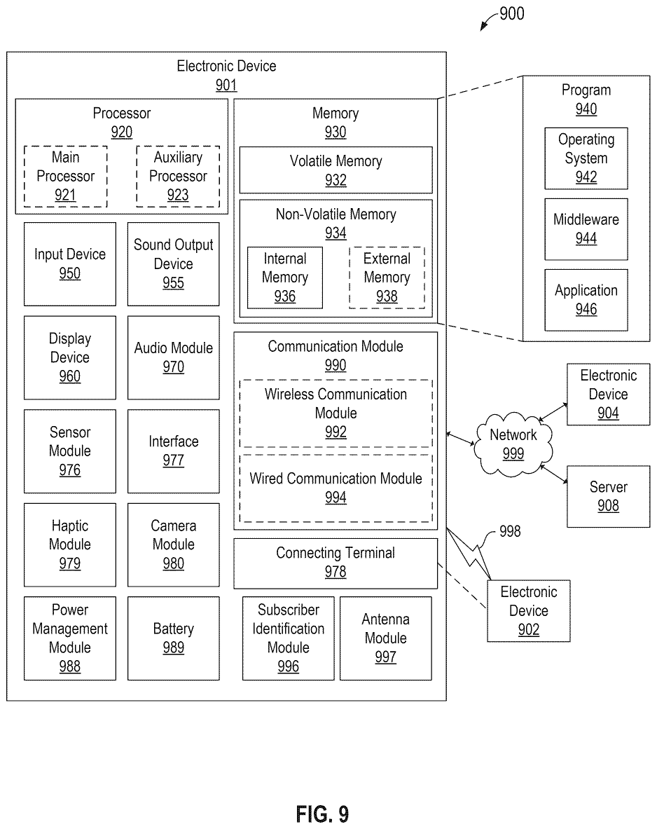

FIG. 9 is a block diagram of an electronic device in a network environment 900, according to an embodiment.

Referring to FIG. 9, an electronic device 901 in a network environment 900 may communicate with an electronic device 902 via a first network 998 (e.g., a short-range wireless communication network), or an electronic device 804 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

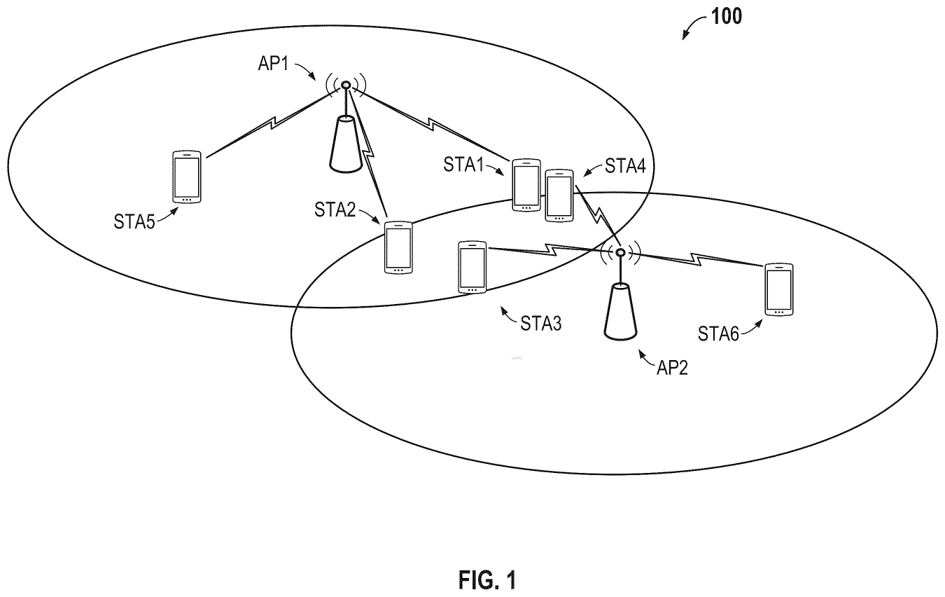

The processor 920 may execute software (e.g., a program 940) to control at least one other component (e.g., a hardware or a software component) of the electronic device 901 coupled with the processor 920 and may perform various data processing or computations. For example, the processor 920 may perform steps related to optimal singular value decomposition based beamforming. For example, the electronic device 901 may be, with reference to FIG. 1, the STA1. The processor 920 can accordingly form, with a STA1, a normalized-optimal STA1 CSI feedback matrix V̅₁ with an optimal STA1-AP1 intra-BSS right singular matrix \tilde{V}₁₁, a normalized new STA1-AP2 cross-BSS right singular matrix

$${\overline{V}}_{12}^{new} ,$$

and a null matrix and sending the normalized-optimal STA1 CSI feedback matrix V̅₁ to the AP1 and AP2 for more than one type of beamforming.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor) and supports a direct (e.g., wired) communication or a wireless communication.

The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

FIG. 10 shows a system 1000 including an AP1 1010, an AP2 1020, and a STA 1030.

Referring to FIG. 10, the AP1 1010 is communicatively coupled with the STA 1030 illustrated by a solid line. The AP1 1010 may be communicatively coupled with the STA 1030 via wireless uplinks and/or downlinks. The AP1 1010 and the AP2 1020 are also communicatively coupled with each other as is also illustrated by a solid line. The AP1 1010 and the AP2 1020 may be communicatively coupled with each other through backhaul connections, fronthaul wireless communications, and/or etc. The AP2 1020 and the STA 1030 are not shown as being communicatively coupled but instead include some transmissions, direct or indirect between the AP2 1020 and the STA 1030 as is illustrated by the dashed arrow line.

With reference to FIGS. 1 and 10, the AP1 1010 and the STA 1030 may be considered associated with each other and thus be part of a BSS. For example, the STA 1030 may be the STA2 shown in FIG. 1. Accordingly, the BSS that includes the AP1 1010 and the STA 1030 shown in FIG. 10 may overlap with another BSS that includes the AP2 1020 and thus may be an OBSS. The AP2 1020 may therefore, for example, overhear communications between the AP1 1010 and the STA 1030 even though the AP2 1020 may not be communicatively coupled with (e.g., associated with) the STA 1030.

The AP1 1010 and the AP2 1020 may be any suitable combination of hardware and/or software that can provide wireless services to the STA 1030. For example, the AP1 1010 and the AP2 1020 may respectively be comprised of a processing circuit 1012, 1022 and a transmitter/receiver 1014, 1024. The processing circuits 1012, 1022 may be any suitable combination of circuits, registers, code, and/or the like that can perform computations, such as, for example, those described herein. Additionally or alternatively, the AP1 1010 and the AP2 1020 may be comprised of antennas (e.g., in one or more antenna arrays) for communications with, for example, the STA 1030 and/or each other, a wired network interface to a router or switch, and/or the like. It should be appreciated that the term “access point” may be interchangeable with other terms such as “base station”, Next-Generation Node B (gNB), etc.

The STA 1030 may include a radio 1032 and a processing circuit 1034. The radio 1032 which may perform various methods disclosed herein. For example, the processing circuit 1034 may receive, via the radio 1032, transmissions from the AP1 1010, and the processing circuit 1020 may transmit, via the radio 1032, signals to the AP1 1010. Accordingly, the AP1 1010 can transmit, for example, packets with or without data (e.g., symbols) via a transmission (e.g., across specific spatial stream) from the AP1 1010 to the STA 1030.

The processing circuit 1034 can perform steps related to optimal singular value decomposition based beamforming. For example, the processing circuit 1034 can form a normalized-optimal STA CSI feedback matrix V̅₁ with an optimal STA-first access point (AP1) intra-basic service set (BSS) right singular matrix \tilde{V}₁₁, a new STA-second access point (AP2) cross-BSS normalized right singular matrix

$${\overline{V}}_{12}^{new} ,$$

and a null matrix. The radio 1032 may be configured to send the normalized-optimal STA CSI feedback matrix V̅₁ to the AP1 and the AP2 for more than one type of beamforming.

It should also be appreciated that the AP2 1020 can also transmit to the STA 1030 even though the AP2 1020 and the STA 1030 may not be associated. For example, the AP1 1010 and/or the AP2 1020 may transmit an NDPA to coordinate sequential and/or simultaneous transmissions from AP1 1010 and/or AP2 1020 to the STA 1030 as is described in the foregoing. By way of illustration, based on the NDPA, the AP1 1010 and/or the AP2 1020 can transmit an NDP, simultaneously, sequentially, or individually, to the STA 1030.

For example, the AP1 1010, AP2 1020, and/or STA 1030 can perform some of an optimal SVD based beamforming. For example, the STA 1030 may form a normalized-optimal STA1 CSI feedback matrix V̅₁ with an optimal STA1-AP1 intra-BSS right singular matrix \tilde{V}₁₁, a normalized new STA1-AP2 cross-BSS right singular matrix

$${\overline{V}}_{12}^{n e w} ,$$

and a null matrix and sending the normalized-optimal STA1 CSI feedback matrix V̅₁ to the AP1 1010 and AP2 1020 for more than one type of beamforming. The AP1 1010 and AP2 1020 may perform other steps for optimal SVD based beamforming, such as those described with reference to FIG. 8.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
forming, with a first station (STA1), a normalized-optimal STA1 channel state information (CSI) feedback matrix V̅₁ with an optimal STA1-first access point (AP1) intra-basic service set (BSS) right singular matrix \tilde{V}₁₁, a normalized new STA1-second access point (AP2) cross-BSS right singular matrix
$${\overline{V}}_{12}^{new} ,$$
and a null matrix; and
sending, with the STA1, the normalized-optimal STA1 CSI feedback matrix V̅₁ to the AP1 and AP2 for more than one type of beamforming.

2. The method of claim 1, wherein the normalized-optimal STA1 CSI feedback matrix V̅₁ has a form equivalent to a normalized-regular STA1 CSI feedback matrix V̅₁ including a normalized STA1-AP1 intra-BSS right singular matrix V̅₁₁.

3. The method of claim 1, wherein sending, with the STA1, the normalized-optimal STA1 CSI feedback matrix V̅₁ to the AP1 for beamforming comprises sending, with the STA1, the normalized-optimal STA1 CSI feedback matrix V̅₁ to the AP1 via a joint feedback mechanism.

4. The method of claim 1, wherein sending, with the STA1, the normalized-optimal STA1 CSI feedback matrix V̅₁ to the AP1 for beamforming comprises sending, with the STA1, the normalized-optimal STA1 CSI feedback matrix V̅₁ to the AP1 for single-user multiple-input and multiple-output (SU-MIMO) beamforming by the AP1.

5. The method of claim 1, further comprising determining, with the AP1, if the normalized-optimal STA1 CSI feedback matrix V̅₁ is formed using one of a default joint separated singular value decomposition (SVD), a regular separated SVD, or an optimal separated SVD.

6. The method of claim 5, wherein determining, with the AP1, if the normalized-optimal STA1 CSI feedback matrix V̅₁ is formed using one of a default joint SVD, a regular separated SVD, or an optimal separated SVD is based on one of a structure of the normalized-optimal STA1 CSI feedback matrix V̅₁ or an indication transmitted by the STA1 to the AP1.

7. The method of claim 1, further comprising transmitting, by the STA1, to the AP1 at least one of:
an SVD calculation indication that the CSI STA1 feedback matrix V̅₁ is determined using one of a default SVD or a regular separated SVD, or an optimal separated SVD; and
a feedback type indication that the normalized-optimal STA1 CSI feedback matrix V̅₁ is determined based on one of a regular separated SVD or an optimal separated SVD.

8. The method of claim 1, further comprising extracting, with the AP1, the optimal STA1-AP1 intra-BSS right singular matrix \tilde{V}₁₁ from the normalized-optimal STA1 CSI feedback matrix V̅₁.

9. The method of claim 1, further comprising:
performing, with the AP1, an intra-BSS sounding of the STA1 to obtain the STA1-AP1 intra-BSS right singular matrix V₁₁;
determining, with the STA1, an optimal STA1-AP1 intra-BSS right singular matrix \tilde{V}₁₁ based on the STA1-AP1 intra-BSS right singular matrix V₁₁ and an optimization criterion; and
performing, with the AP2, a cross-BSS sounding of the STA1 to determine a normalized new STA1-AP2 cross-BSS right singular matrix
$${\overline{V}}_{12}^{New} .$$

10. The method of claim 9, wherein performing, with the AP2, the cross-BSS sounding of the STA1 to determine the normalized new STA1-AP2 cross-BSS right singular matrix
$${\overline{V}}_{12}^{New}$$
comprises:
performing, with the AP2, the cross-BSS sounding of the STA1;
determining, with the STA1, an STA1-AP2 cross-BSS channel matrix H₁₂ based on the cross-BSS sounding of the STA1 by the AP2; and
determining, with the STA1, a new STA1-AP2 cross-BSS channel matrix
$${H}_{12}^{New}$$
based on the STA1-AP2 cross-BSS channel matrix H₁₂ and an STA1 processing matrix Q₁ determined based on a Hermitian transpose of the STA1-AP1 intra-BSS left singular matrix U₁₁; and
determining, with the STA1, the normalized new STA1-AP2 cross-BSS right singular matrix
$${\overline{V}}_{12}^{New}$$
based on the new STA1-AP2 cross-BSS channel matrix
$${H}_{12}^{New} .$$

11. The method of claim 1, further comprising transmitting, with the AP1, instructions to the STA1 to perform one of a default joint SVD, regular separated SVD, and the optimal separated SVD to determine the normalized-optimal AP1 CSI feedback matrix V̅₁.

12. A station (STA) comprising:
a processing circuit configured to form a normalized-optimal STA CSI feedback matrix V̅₁ with an optimal STA-first access point (AP1) intra-basic service set (BSS) right singular matrix \tilde{V}₁₁, a new STA-second access point (AP2) cross-BSS normalized right singular matrix
$${\overline{V}}_{12}^{new} ,$$
and a null matrix; and
a transmitter/receiver configured to send the normalized-optimal STA CSI feedback matrix V̅₁ to the AP1 and the AP2 for more than one type of beamforming.

13. The STA of claim 12, wherein the normalized-optimal STA CSI feedback matrix V̅₁ for beamforming has a form equivalent to a normalized-regular STA CSI feedback matrix V̅₁ formed including a normalized STA-AP1 intra-BSS right singular matrix V̅₁₁.

14. The STA of claim 12, wherein the transmitter/receiver being configured to send the normalized-optimal STA CSI feedback matrix V̅₁ to the AP1 for beamforming comprises the transmitter/receiver being configured to send the normalized-optimal STA CSI feedback matrix V̅₁ to the AP1 via a Co-BF joint feedback mechanism.

15. The STA of claim 12, wherein transmitter/receiver being configured to send the normalized-optimal STA CSI feedback matrix V̅₁ to the AP1 for beamforming comprises the transmitter/receiver being configured to send the normalized-optimal STA CSI feedback matrix V̅₁ to the AP1 for singular-user multiple-input and multiple-output (SU-MIMO) beamforming by the AP1.

16. The STA of claim 12, further comprising the transmitter/receiver being configured to transmit to the AP1 at least one of:
a singular value decomposition (SVD) calculation indication that the CSI STA CSI feedback matrix V̅₁ is determined using one of a default SVD or a separated SVD; and
a feedback type indication that the normalized-optimal STA CSI feedback matrix V̅₁ is determined based on one of a regular separated SVD or an optimal separated SVD.

17. A system comprising:
a first access point (AP1); and
a station (STA) communicatively coupled with the AP1, the STA being configured to form a normalized-optimal STA CSI feedback matrix V̅₁ with an optimal STA-AP1 intra-basic service set (BSS) right singular matrix \tilde{V}₁₁, a normalized new STA-second access point (AP2) cross-BSS right singular matrix
$${\overline{V}}_{12}^{new} ,$$
and a null matrix and a transmitter/receiver configured to send the normalized-optimal STA CSI feedback matrix V̅₁ to the AP1 and the AP2 for more than one type of beamforming.

18. The system of claim 17, further comprising the AP1 being configured to determine if the normalized-optimal STA CSI feedback matrix V̅₁ is formed using one of a default joint separated singular value decomposition (SVD), a regular separated SVD, or an optimal separated SVD.

19. The system of claim 18, wherein the AP1 being configured to determine if the normalized-optimal STA CSI feedback matrix V̅₁ is formed using one of a default joint SVD, a regular separated SVD, or an optimal separated SVD is based on one of a structure of the normalized-optimal STA CSI feedback matrix V̅₁ or an indication transmitted by the STA to the AP1.

20. The system of claim 17, further comprising the AP1 being configured to extract the optimal STA-AP1 intra-BSS right singular matrix \tilde{V}₁₁ from the normalized-optimal STA CSI feedback matrix V̅₁.

21. The system of claim 20, further comprising:
the AP1 being configured to perform an intra-BSS sounding of the STA to obtain the STA-AP1 intra-BSS right singular matrix V₁₁;
the STA being configured to determine an optimal STA-AP1 intra-BSS right singular matrix \tilde{V}₁₁ based on the STA-AP1 intra-BSS right singular matrix V₁₁ and an optimization criteria; and
an AP2 being configured to perform a cross-BSS sounding of the STA to determine a normalized new STA-AP2 cross-BSS right singular matrix
$${\overline{V}}_{12}^{New} .$$

22. The system of claim 21, wherein the AP2 being configured to perform the cross-BSS sounding of the STA to determine the normalized new STA-AP2 cross-BSS right singular matrix
$${\overline{V}}_{12}^{New}$$
comprises:
the AP2 being configured to perform the cross-BSS sounding of the STA;
the STA being configured to determine an STA-AP2 cross-BSS channel matrix H₁₂ based on the cross-BSS sounding of the STA by the AP2; and
the STA being configured to determine a new STA-AP2 cross-BSS channel matrix
$${H}_{12}^{New}$$
based on the STA-AP2 cross-BSS channel matrix H₁₂ and an STA processing matrix Q₁ determined based on a Hermitian transpose of the STA-AP1 intra-BSS left singular matrix U₁₁; and
the STA being configured to determine the normalized new STA-AP2 cross-BSS right singular matrix
$${\overline{V}}_{12}^{New}$$
based on the new STA-AP2 cross-BSS channel matrix
$${H}_{12}^{New} .$$

23. The system of claim 17, further comprising the AP1 being configured to transmit instructions to the STA to perform one of a default joint SVD, a regular separated SVD, and an optimal separated SVD to determine the determine the normalized-optimal AP1 CSI feedback matrix V̅₁.
